(19) United States
(12) Patent Application Publication
(10) Pub. No.: US 2007/0028127 A1
(43) Pub. Date: Feb. 1, 2007

(54) Universal serial bus system, and method of driving the same

(75) Inventor: Hak-Soo Kim, Suwon-si (KR)

Correspondence Address: F. CHAU & ASSOCIATES, LLC, 130 WOODBURY ROAD, WOODBURY, NY, 11797, US

(73) Assignee: Samsung Electronics Co., LTD.

(21) Appl. No.: 11/481,779

(22) Filed: Jul. 6, 2006

(30) Foreign Application Priority Data
Jul. 26, 2005 (KR) 10-2005-68033

(51) Int. Cl. G06F 1/00; G06F 13/14

(52) U.S. Cl. 713/310; 710/305

(57) ABSTRACT

A universal serial bus (USB) system includes a host device and at least one client device connected with the host device through a USB connection. In a communication deadlock condition between the host device and client device, the host device interrupts a power supply to the client device and resumes the power supply to the client device after an initialization, wherein the communication condition between the host device and client device is automatically re-established from the deadlock condition.

### CROSS-REFERENCE TO RELATED APPLICATIONS

This U.S. non-provisional patent application claims priority under 35 U.S.C. § 119 to Korean Patent Application 2005-68033 filed on Jul. 26, 2005, the entire contents of which are herein incorporated by reference.

### BACKGROUND OF THE INVENTION

1. Field of the Invention

The subject matter disclosed herein is concerned with serial bus systems. In particular, the subject matter disclosed herein relates to universal serial bus systems and methods of driving the same.

2. Discussion of Related Art

Universal Serial Bus (hereinafter, referred to as ‘USB’) is a standard for supporting a plug-and-play installation function, different from conventional serial/parallel connections (e.g., RS232, LPT, and so on), between computer systems and peripheral devices. In connecting computer systems with peripheral devices, the USB standard supports dynamic connection/disconnection management and does not need systemic shut-down or rebooting of the computer system. Further, the number of ports is extendable, wherein a single USB system is linkable with up to 127 devices. The USB system also supports real-time data transmission. Such USB systems are widely employed in communication apparatuses for transmitting digital multimedia, e.g., mobile phones, camcorders, and digital cameras.

A single USB system is configured with a USB host as a system core, at least one USB client offering a function, and a USB inter-connector linking the USB host with the USB client in accordance with bus topology. USB systems may be classified into low, full, and high-speed types according to data transmission rate. The low speed type is operable in data rate of 1.5 Mbps, adaptable to keyboard, mouse, joystick, speakers, etc. The full speed type is operable in data rate of 12 Mbps, adaptable to hard disc, scanner, printer, and the like. And, the high-speed type is adaptable to, for example, a video storage device needing a high bandwidth, operable in data rate of up to 480 Mbps.

During USB communication a ‘deadlock condition’ may occur, where the communication cannot continue due to errors caused during data communication.

During data communication between a USB host and a USB client, if one side lapses into the deadlock condition, the USB data communication cannot continue. For example, owing to communication errors between two USB devices, if data arriving at one device (e.g., the receiving system) has a length longer than an actual length of data sent from the other device (e.g., the transmitting system), the receiving device is held indefinitely in a data reception state for accepting data even after substantially completing the data transfer from the transmitting device. In this case, the communication between the two devices lapses into the deadlock condition. As another example, if a data buffering malfunction occurs at the receiving device during data communication, the transmitting device is put into a standby state indefinitely, which causes both the devices to fall in the communicational deadlock state.

To recover an operation of communication between both the USB devices being held in the deadlock condition, the USB connection needs to be removed and reconnected from between the devices by a user.

Therefore, a need exists for a USB system and method for re-establishing USB communications.

### SUMMARY OF THE INVENTION

According to an embodiment of the present invention a USB system comprises a host device, and at least one client device connected to the host device through a USB connection, in which the host interrupts a power supply to the client device through a power line when there is a deadlock condition and resumes the power supply to the client device after an initialization.

The host device comprises a first switch connected to the power line for regulating the power supply to the client device.

The client device comprises a pull-up resistor connected to a data line of the USB connection, the pull-up resistor being connected with a second switch.

The second switch disconnects the data line from the pull-up resistor when the power supply through the power line is interrupted, and connects the data line with the pull-up resistor when the power supply resumes.

The host device detects connection between the host device and the client device in response to a condition of the data line.

The host device comprises a deadlock detector to detect the deadlock condition.

The first switch is controlled in response to a detection result of the deadlock detector.

According to an embodiment of the present invention, a USB system is comprises a downstream port transceiver connected to a USB connection, a deadlock detector detecting a deadlock condition in response to a signal input to the downstream port transceiver, and a switch connected between the downstream port transceiver and a power line of the USB connection. The switch controls power supply through the power line in accordance with a detection result of the deadlock detector.

The switch interrupts the power supply when there is the deadlock condition.

According to an embodiment of the present invention, a USB system comprises a host device, and a client device connected to the host device through a USB connection. Responding to a deadlock condition, the client device disconnects a pull-up resistor from a data line of the USB connection while the host device interrupts a power supply to the client device through a power line of the USB connection in response to a signal of the data line and resumes the power supply to the client device after an initialization.

The host device comprises a first switch to regulate the power supply.

The client device comprises a second switch to regulate connection between the data line and the pull-up resistor.

The client device comprises a deadlock detector to detect the deadlock condition.

The second switch is controlled in response to a detection result of the deadlock detector.

According to an embodiment of the present invention a method of driving a USB system including a host device and a client device connected to the host device through a USB connection comprises of detecting a deadlock condition, interrupting a power supply through a power line in response to the deadlock condition, detecting a disconnection between the host device and the client device and conducting an initialization, and resuming the power supply through the power line after the initialization.

The host device comprises a first switch connected with the power line for regulating the power supply to the client device.

The client device comprises a pull-up resistor connected to a data line of the USB connection, the pull-up resistor being connected with a second switch.

The second switch disconnects the data line from the pull-up resistor when the power supply through the power line is interrupted, and connects the data line with the pull-up resistor when the power supply resumes.

The host detects connection between the host device and the client device in response to a condition of the data line.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified. In the figures:

FIG. 1 is a block diagram of a USB system in accordance with an embodiment of the invention;

FIG. 2 is a timing diagram illustrating an operation of the USB system shown in FIG. 1;

FIG. 3 is a transition diagram illustrating an operation of the USB system shown in FIG. 1;

FIG. 4 is a block diagram of a USB system in accordance with an embodiment of the invention;

FIG. 5 is a timing diagram illustrating an operation of the USB system shown in FIG. 4;

FIG. 6 is a transition diagram illustrating an operation of the USB system shown in FIG. 4;

FIG. 7 is a transition diagram illustrating another operation of the USB system shown in FIG. 4;

FIG. 8 is a transition diagram illustrating still another operation of the USB system shown in FIG. 4;

FIG. 9 is a block diagram of a USB system in accordance with an embodiment of the invention;

FIG. 10 is a timing diagram illustrating an operation of the USB system shown in FIG. 9;

FIG. 11 is a transition diagram illustrating an operation of the USB system shown in FIG. 9;

FIG. 12 is a transition diagram illustrating another operation of the USB system shown in FIG. 9; and

FIG. 13 is a transition diagram illustrating still another operation of the USB system shown in FIG. 9.

### DETAILED DESCRIPTION OF PREFERRED EMBODIMENTS

Preferred embodiments of the invention will be described below in more detail with reference to the accompanying drawings. The invention may, however, be embodied in different forms and should not be constructed as limited to embodiments set forth herein. Rather, embodiments are provided so that this disclosure will be thorough and complete, and will fully convey the scope of the invention to those skilled in the art.

Hereinafter, exemplary embodiments of the invention will be described in conjunction with the accompanying drawings.

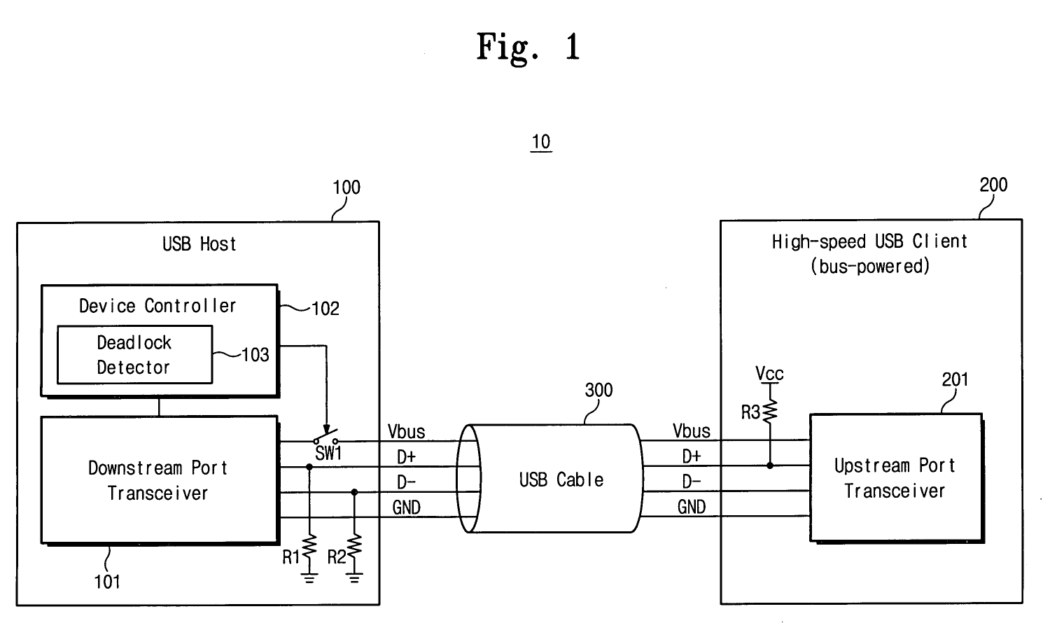

FIG. 1 is a block diagram of a USB system in accordance with an embodiment of the invention. The USB system 10 is composed of a USB host 100, a bus-powered high-speed USB client 200, and a USB cable 300.

The USB host 100 comprises a downstream port transceiver 101 and a device controller 102. The downstream port transceiver 101 functions as a connection part for data communication with the bus-powered high-speed USB client 200. The downstream port transceiver 101 is connected with a pair of data lines D+ and D−, a power line Vbus, and a ground line GND. The data lines D+ and D− of the downstream port transceiver 101 are each connected to pull-down resistors R1 and R2. The pull-down resistors R1 and R2 have values of about 15 KΩ. The power line Vbus of the downstream port transceiver 101 supplies about a 5V power to the bus-powered high-speed USB client 200. A switch SW1 connected to the power line Vbus controls a power supply operation when a deadlock condition occurs. The device controller 102 includes a deadlock detector 103. The deadlock detector 103 senses a deadlock condition of the USB system 10 in response to a signal input from the downstream port transceiver 101. With the detection result for a deadlock condition, the device controller 102 regulates the switch SW1 connected to the power line Vbus.

The USB device is generally classified into a bus-powered type (as like 200 of FIG. 1) operating with power from the USB host (100 of FIG. 1) and a self-powered type operating by itself. The bus-powered USB client 200 shown in FIG. 1 operated with power supplied from the USB host 100.

The bus-powered USB client 200 includes an upstream port transceiver 201. The downstream port transceiver 101 functions as a connection part for data communication with the USB host 100. The downstream port transceiver 101 is connected with the data lines D+ and D−, the power line Vbus, and the ground line GND. The positive data line D+ of the upstream port transceiver 201 is connected to the pull-up resistor R3. A value of the pull-up resistor R3 is about 1.5 KΩ. As the USB client 200 of FIG. 1 is designed to be operable in the full or high-speed mode, the pull-up resistor R3 is connected to the positive data line D+. If the USB client 200 is designed to be operable in the low-speed mode, the pull-up resistor R3 will be connected to the negative data line D−. The pull-up resistor R3 is supplied with an internal voltage Vcc. The internal voltage Vcc for the bus-powered high-speed USB client 200 is converted from a power voltage that is supplied through the power line Vbus from the USB host 100.

The USB cable 300 acts as a channel for connecting the USB host 100 with the bus-powered high-speed USB client 200.

The USB host 100 confirms the presence of connection with the bus-powered high-speed USB client 200. If both the data lines D+ and D− are maintained at low levels for a predetermined time (e.g., more than 2.5 μs), the USB host 100 determines that there is no connection with the bus-powered high-speed USB client 200, which is called ‘single-ended 0’ (SE0) state. If one of the data lines D+ and D− is maintained at a low level, lower than a high level, for a predetermined time (e.g., more than 2.5 μs), the USB host 100 determines that there is a connection with the bus-powered high-speed USB client 200.

According to the data lines D+ and D− for the connection between the USB host 100 and client 200 in the USB system 10, the USB host 100 detects the presence of the connection with the bus-powered high-speed USB client 200. If there is a deadlock condition in the USB system 10, communications between the USB host 100 and the bus-powered high-speed USB client 200 is re-established without physically removing and linking the USB cable 300 therebetween.

When the device controller 102 of the USB host 100 detects a deadlock condition in the USB system 10, the switch SW1 connected to the power line Vbus of the downstream port transceiver 101 is turned off to interrupt power supply to the bus-powered high-speed USB client 200. As a result, the bus-powered high-speed USB client 200, which is driven by the power supply from the USB device 100, stops operating. If the bus-powered high-speed USB client 200 is interrupted during operation, the supply of the internal voltage Vcc is suspended to maintain both the data lines D+ and D− at low levels. In the SE0 state, the USB host 100 detects a state of disconnection with the bus-powered high-speed USB device 200. After a predetermined time the USB host 100 initializes an internal condition and turns the switch SW1 on to supply power to the bus-powered high-speed USB device 200. If the power is supplied to the bus-powered high-speed USB client 200, the pull-up resistor R3 is connected to the internal voltage Vcc and the positive data line D+ is charged up to the high level. While the positive data line D+ is at the high level for a predetermined time, the USB host 100 detects the connection with the bus-powered high-speed USB client 200 and conducts data communication with the bus-powered high-speed USB client 200.

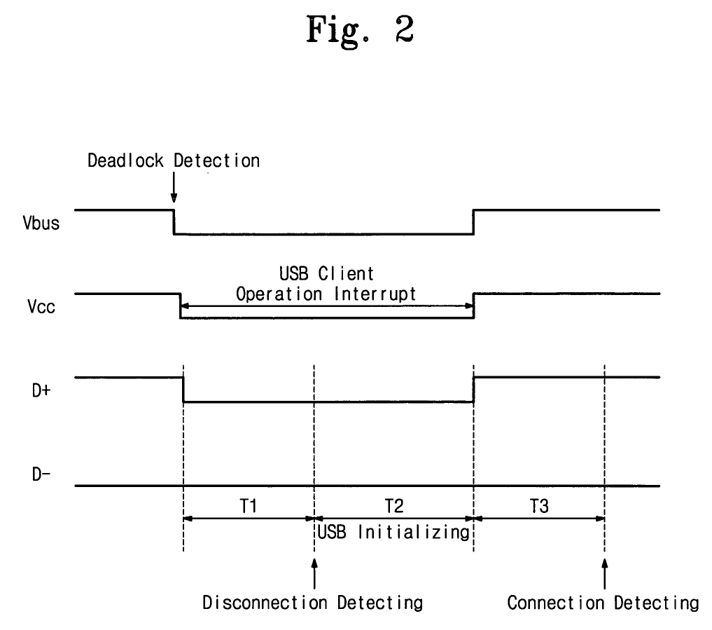

FIG. 2 is a timing diagram illustrating an operation of the USB system 10 shown in FIG. 1.

In FIG. 2, there is shown a voltage signal of the power line Vbus, which is supplied to the bus-powered high-speed USB client 200 from the USB device 100 by an operation of the switch SW1. If the deadlock condition is detected while supplying a power voltage into the bus-powered high-speed USB client 200 through the power line Vbus, the switch SW1 is turned off (i.e., open) to interrupt the power voltage for the bus-powered high-speed USB client 200.

The internal voltage Vcc for the bus-powered high-speed USB device 200 is made from the power voltage supplied through the power line Vbus. If the power voltage supplied to the power line Vbus is interrupted due to the detection of a deadlock condition, the bus-powered high-speed USB client 200 stops operating.

The signals of data lines D+ and D− vary in accordance with the deadlock detection. If the bus-powered high-speed USB client 200 stops operating, the positive data line D+ transitions to the low level from the high level. When both the data lines D+ and D− have low levels for a predetermined time T1, the USB host 100 detects a state of disconnection with the bus-powered high-speed USB client 200. The USB host 100 initializes its internal condition during a predetermined time T2 and turns the switch SW1, which is connected with the power line Vbus, on to supply the power voltage to the bus-powered high-speed USB client 200. After the power supply is supplied, the positive data line D+ transitions up to the high level from the low level. When one of the data lines D+ and D− has the high level for a predetermined time T3, the USB host 100 detects a state of connection with the bus-powered high-speed USB client 200 and resumes data communication with the bus-powered high-speed USB client 200.

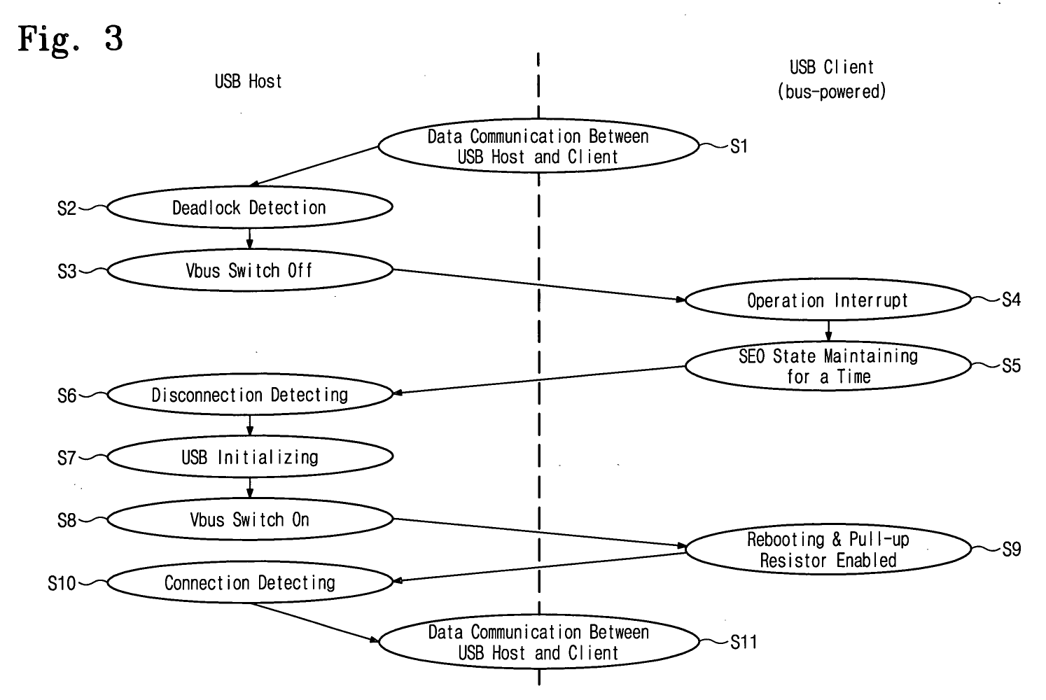

FIG. 3 is a transition diagram illustrating an operation of the USB system 10 shown in FIG. 1. During data communication between the USB host 100 and the bus-powered high-speed USB client 200 (S1), if a deadlock is detected by the USB host 100 (S2), the USB host 100 disables the switch SW1 that is connected to the power line Vbus (S3). If the switch SW1 is turned off, the power supply to the bus-powered high-speed USB client 200 is interrupted to disable the bus-powered high-speed USB client 200 (S4). If the bus-powered high-speed USB client 200 stops operating, the data lines D+ and D− transitioned into the SE0 state, all with low levels (S5). In the SE0 state, the USB host 100 detects disconnection with the bus-powered high-speed USB client 200 (S6) and an internal state of the USB host 100 is initialized (S7). The USB host 100 turns the switch SW1 on (S8) to supply the power voltage to the bus-powered high-speed USB client 200, the switch SW1 being connected to the power line Vbus. By the switch SW1 being turned on, the bus-powered high-speed USB client 200 is rebooted by the power supply and the positive data line D+ is transitioned up to the high level (S9). When one of the data lines D+ and D− has the high level for the predetermined time T3, the USB host 100 detects a state of connection with the bus-powered high-speed USB client 200 (S10) and resumes data communication with the bus-powered high-speed USB client 200 (S11).

FIGS. 1 through 3 illustrate the bus-powered high-speed USB client 200 having the pull-up resistor R3 connected to the positive data line D+, in which according to presence of the power supply, the negative data line D− maintains the low level while the positive data line D+ varies in voltage level. In a bus-powered low-speed USB device with the pull-up resistor R3 connected to the negative data line D−, the positive data line D+ maintains the low level while the negative data line D− varies in voltage level.

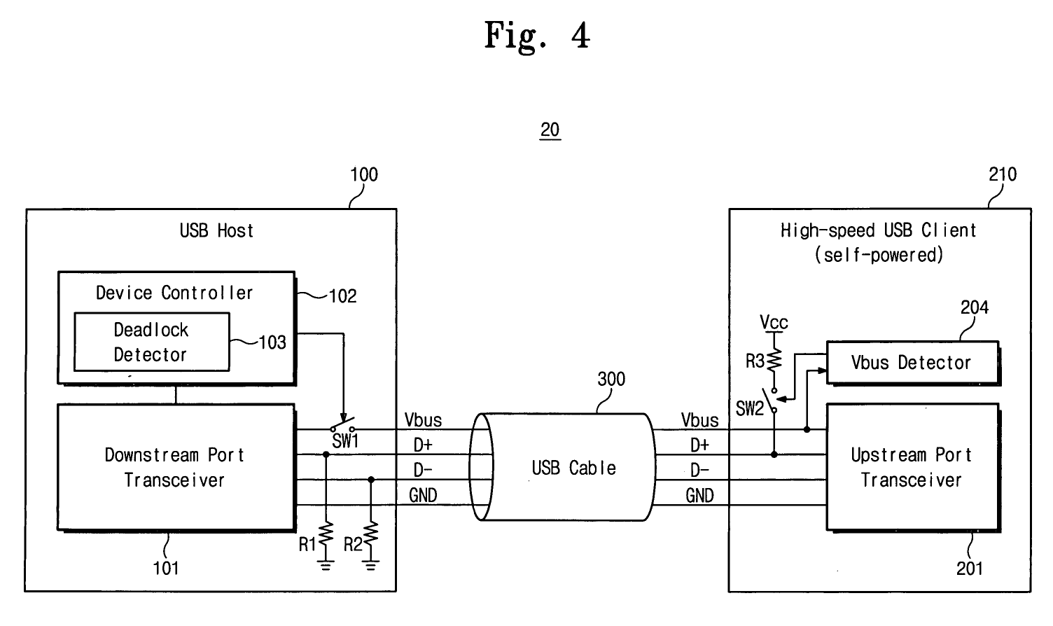

FIG. 4 is a block diagram of a USB system in accordance with an embodiment of the present invention. The USB system 20 shown in FIG. 4 comprises a self-powered high-speed USB device 210.

Referring to FIG. 4, the self-powered high-speed USB client 210 comprises the upstream port transceiver 201 and a Vbus detector 204. The Vbus detector 204 senses a variation of a power voltage supplied through the power line Vbus from the USB host 100 and controls a switch SW2 connected to the pull-up resistor R3. The Vbus detector 204 may be composed of a voltage comparator.

When the device controller 102 of the USB host 100 detects a deadlock condition in the USB system 10, the switch SW1 is turned off to interrupt the power supply through the power line Vbus. The Vbus detector senses the interrupt of power supply through the power line Vbus and turns the switch SW2 off. The switch SW2 is connected to the pull-up resistor R3. If the switch SW2 is shut off, the positive data line D+ transitions to the low level from the high level. When both the data lines D+ and D− are maintained at low levels, the USB host 100 detects a state of disconnection with the self-powered high-speed USB client 210. The USB host 100 initializes its internal condition and turns the switch SW1 on to supply power to the self-powered high-speed USB client 210. The Vbus detector 204 of the self-powered high-speed USB client 210 senses the power supply through the power line Vbus to turn the switch SW2 on. Before turning the switch SW2 on, the self-powered high-speed USB client 210 is internally initialized. If the switch SW2 is turned on, the internal voltage Vcc is charged to set the positive data line D+ at the high level. When the positive data line D+ has the high level for a predetermined time, the USB host 100 detects the connection with the self-powered high-speed USB client 210 and resumes data communication with the self-powered high-speed USB client 210.

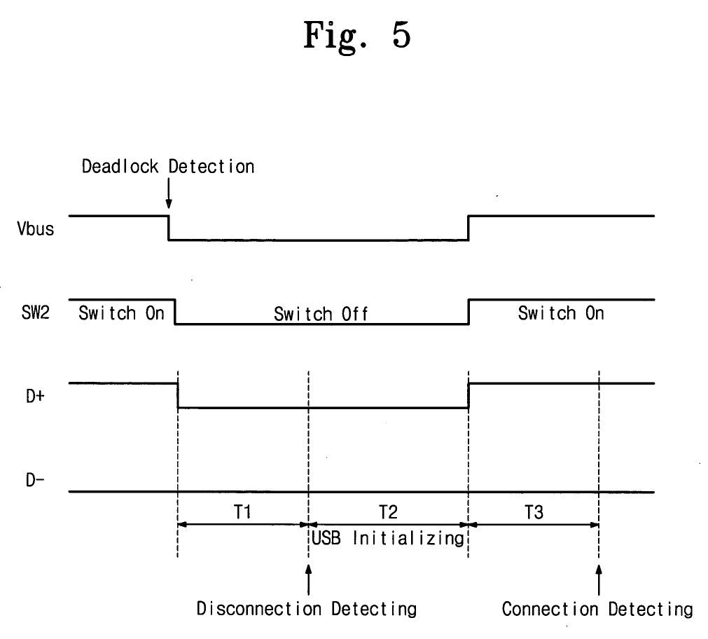

FIG. 5 is a timing diagram illustrating an operation of the USB system 20 shown in FIG. 4.

In FIG. 5, there is shown a voltage variation on the power line Vbus, which is input to the self-powered high-speed USB client 210 from the USB device 100 by an operation of the switch SW1. If a deadlock condition is detected while supplying a power voltage into the self-powered high-speed USB client 210 through the power line Vbus, the switch SW1 is turned off (i.e., open) to interrupt the power voltage supply for the self-powered high-speed USB client 210.

In FIG. 5, there is also illustrated a waveform representing an operation of the switch SW2. If the power supply through the power line Vbus is interrupted due to the detection of a deadlock, the Vbus detector 204 turns the switch SW2 off. If the power supply operation through the power line Vbus resumes, the Vbus detector 204 turns the switch SW2 on.

In the USB system of FIG. 4, the data lines D+ and D− vary in accordance with the deadlock detection. If the switch SW2 of the self-powered high-speed USB client 210 is turned off, the positive data line D+ transitions to the low level from the high level. When both the data lines D+ and D− are maintained at the low level for the predetermined time T1, the USB host 100 detects a state of disconnection with the self-powered high-speed USB client 210. The USB host 100 initializes its internal condition for the predetermined time T2 and turns the switch SW1 on to supply the power voltage to the self-powered high-speed USB client 210. The switch SW1 is connected to the power line Vbus. The Vbus detector 204 turns the switch SW2 on if the power voltage is supplied through the power line Vbus. Responding to the conduction of the switch SW2, the positive data line D+ transitions up to the high level from the low level. When one of the data lines D+ and D− has the high level for the predetermined time T3, the USB host 100 detects a state of connection with the self-powered high-speed USB client 210 and resumes data communication with the self-powered high-speed USB client 210.

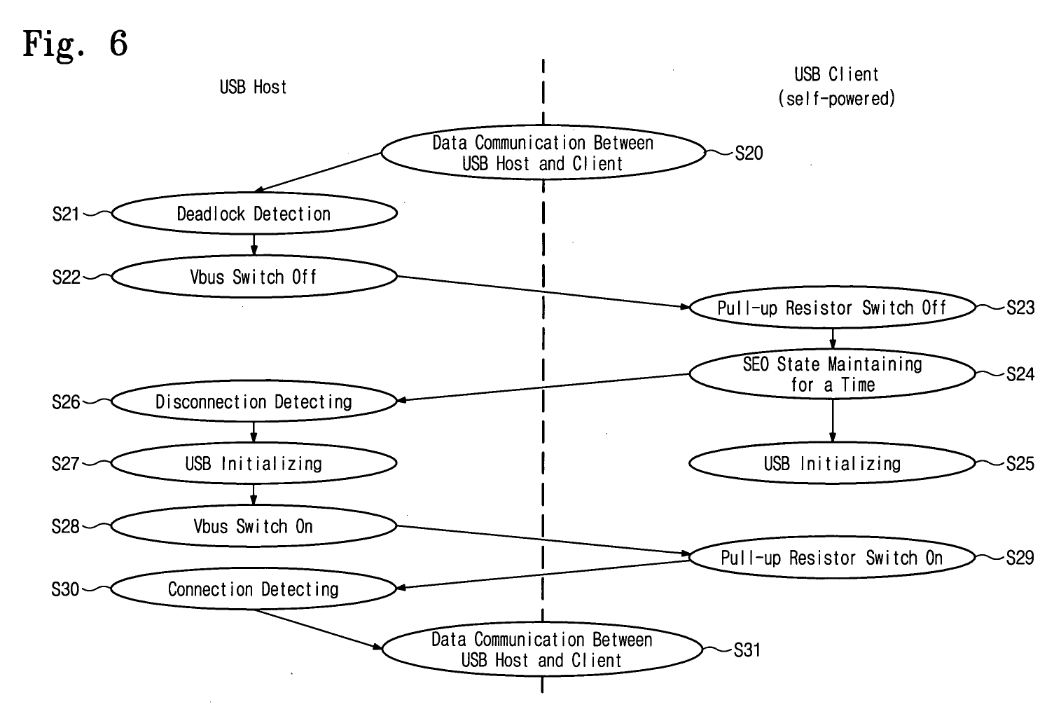

FIG. 6 is a transition diagram illustrating an operation of the USB system 20 shown in FIG. 4. During data communication between the USB host 100 and the self-powered high-speed USB client 210 (S20), if a deadlock condition is detected by the USB host 100 (S21), the USB host 100 disables the switch SW1 that is connected to the power line Vbus (S22). If the switch SW1 is turned off, the power supply through the power line Vbus is interrupted. The Vbus detector 204 shuts off the switch SW2 that is connected to the pull-up resistor SW2 (S23). If the switch SW2 is shut off, the positive data line D+ is transitioned to the low level from the high level, resulting in the SE0 state where the data lines D+ and D− are transitioned to the low level (S24). In the SE0 state, the self-powered high-speed USB client 210 is initialized internally (S25). Upon the USB host 100 identifying the SE0 state, the USB host 100 detects a state of disconnection with the self-powered high-speed USB client 210 (S26). The USB host 100 is internally initialized (S27). The USB host 100 turns the switch SW1 on (S28) to supply the power voltage through the bus line Vbus; the switch SW1 being connected with the power line Vbus. The Vbus detector 204 turns the switch SW2 on (S29) when the power voltage is supplied through the power line Vbus. If the switch SW2 is turned on, the positive data line D+ is transitioned up to the high level from the low level. When one of the data lines D+ and D− is maintained at the high level for the predetermined time T3, the USB host 100 detects a state of connection with the self-powered high-speed USB client 210 (S30) and resumes data communication with the bus-powered high-speed USB device 200 (S31).

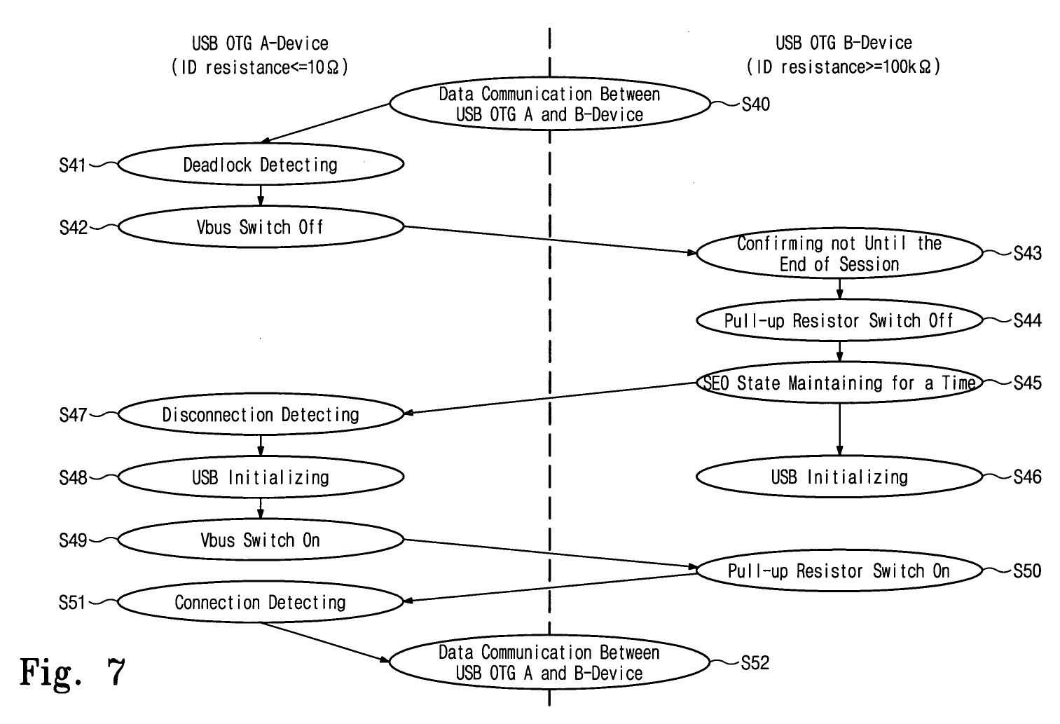

FIG. 7 is a transition diagram illustrating another operation of the USB system 20 shown in FIG. 4. The USB system 20 of FIG. 7 comprises a USB OTG A-device and a USB OTG B-device, replacing the USB host 100 and the self-powered high-speed USB client 210 of FIG. 6.

The USB OTG (on-the-go) devices conform to the USB 2.0 standard, having the merits thereof. For example, USB OTG enables data communications between USB devices, e.g., for exchanging files between MP3 players, or connecting a digital camera with a photo-printer.

Within a system comprising two USB OTG devices connected to each other, a determining which of device functions as a host a which device functions as a device is made. For this determination, the USB OTG system employs an ID line, by which the functional determination is dependent on a condition of the ID line. If the ID line of a USB OTG device is connected with the ground line GND, it is set as the host, which is referred as the USB OTG A-device. If the ID line of a USB OTG device is floated without an electrical connection, it is set as the device, which is referred as the USB OTG B-device.

Changing the functions of the host and device with the two USB OTG systems can be accomplished by using host negotiation protocol (HNP).

The flow of state transitions shown in FIG. 7 includes confirming the end of session (S42) when the USB OTG A-device detects a deadlock condition (S41) and turns the switch SW1 on (S42), the switch SW1 being connected to the power line Vbus. In the USB OTG system according to the session request protocol (SRP), power supplied through the power line Vbus is interrupted at the end of session where its operation is completed. Thus, it may not be permissible for the Vbus detector 204 of the USB OTG B-device to identify a deadlock from the suspension of the power supply through the power line Vbus. The USB OTG B-device identifies the deadlock when the power supply through the power line Vbus is interrupted while one of the data lines D+ and D− is at the high level. Other operations are same with those illustrated in FIG. 6.

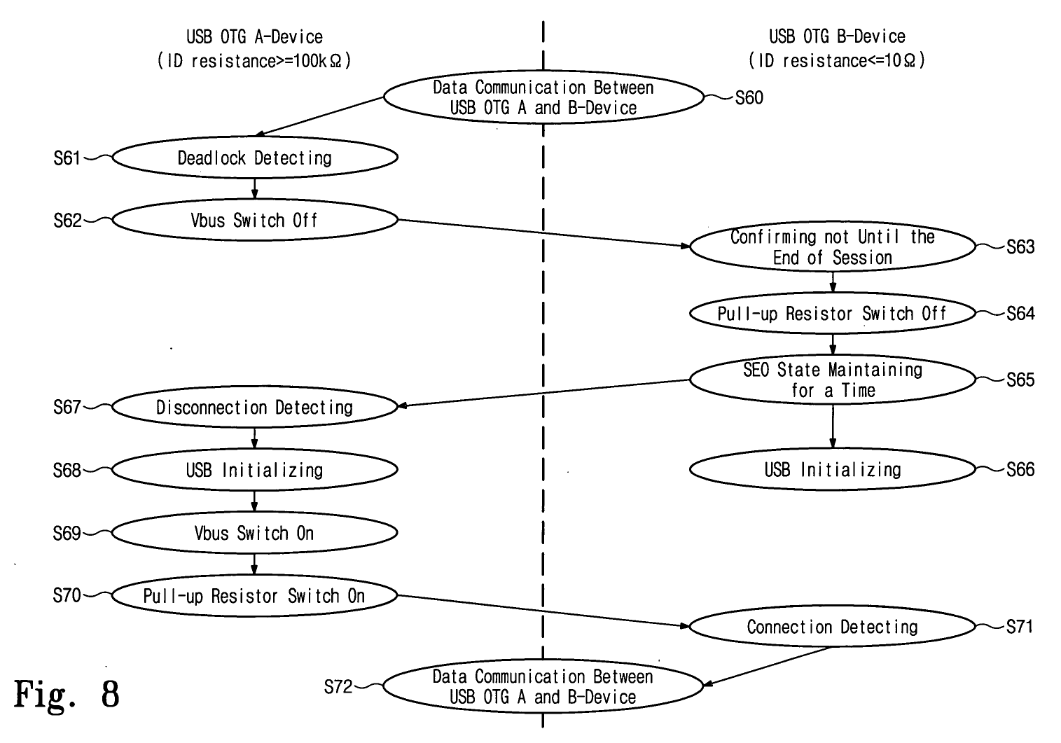

FIG. 8 is a transition diagram illustrating still another operation of the USB system shown in FIG. 4. The USB OTG system shown in FIG. 8 is set by altering the functions of the host and device from the USB OTG system of FIG. 7 by means of HNP. When the functions of the USB host and device are changed by HNP while the USB OTG system is operating, a deadlock condition occurs to cut off a connection between the two USB devices and the allocation of functions is re-established as an initial configuration when the devices are reconnected. Thereafter, if the functions are to be changed, they are changed by means of HNP. For example, it is assumed that the first USB OTG device is initially set as functioning as the USB host while the second USB OTG device acts as the USB client. If there is a need of changing the functions to each other, data communication is carried out under the configuration that the first USB OTG device acts as the USB client while the second USB OTB device acts as the USB host. During this data communication, if a deadlock condition occurs, the switches SW1 and SW2 disconnect and connect the first USB OTB device of the USB client with the second USB OTG device as the USB host. Then, according to the initial set configuration, the first USB OTG device returns to function as the USB host and the second USB OTG device returns to function as the USB client.

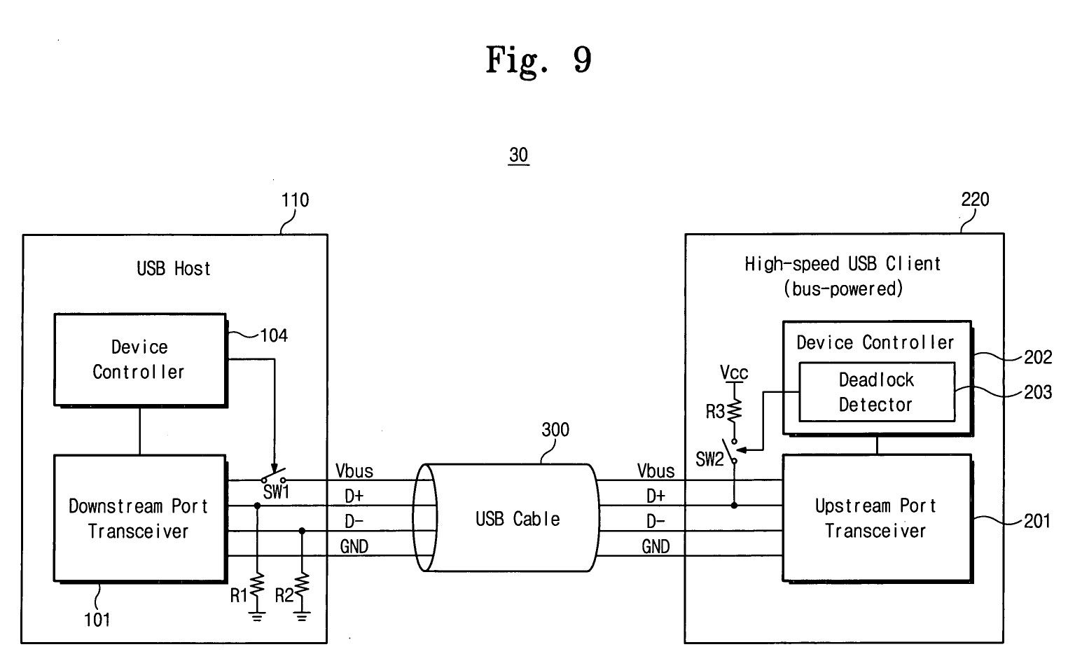

FIG. 9 is a block diagram of a USB system in accordance with an embodiment of the invention. The USB system 30 shown in FIG. 9 comprises a deadlock detector 203 included in a high-speed USB device 220.

A USB host 110 comprises the downstream port transceiver 101 and a device controller 104. The device controller 104 regulates the switch SW1 connected to the power line Vbus.

The high-speed USB client 220 comprises a device controller 202 that includes a deadlock detector 204. The device controller 202 regulates the switch SW2 connected to the pull-up resistor R3.

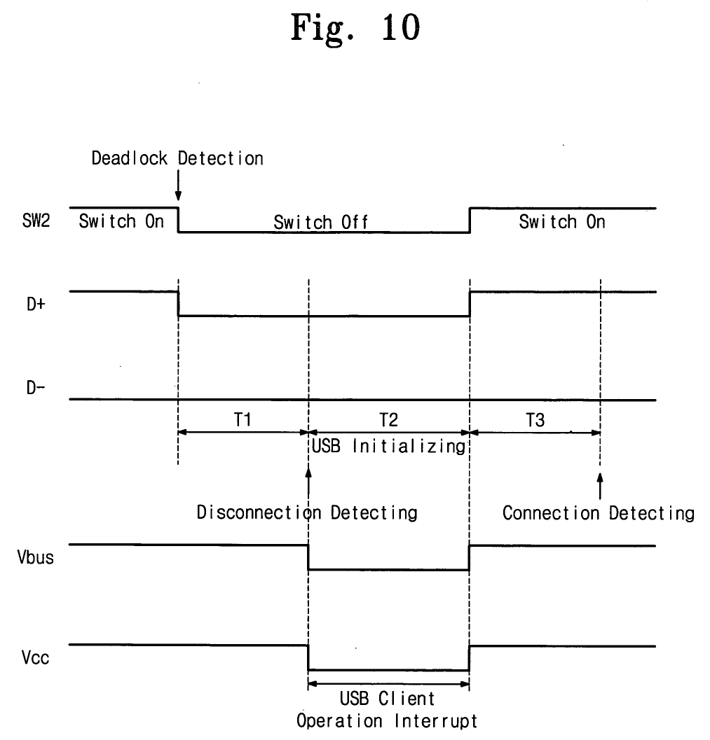

FIG. 10 is a timing diagram illustrating an operation of the USB system shown in FIG. 9. In FIG. 10, there is also illustrated a waveform representing an operation feature of the switch SW2 regulated by the device controller 202. If a deadlock is detected, the device controller 202 turns the switch SW2 off. If the power supply operation through the power line Vbus resumes, the device controller 202 turns the switch SW2 on.

In the USB system of FIG. 4, the data lines D+ and D− are also variable in accordance with the deadlock detection. If the switch SW2 of the bus-powered high-speed USB device 220 is turned off, the positive data line D+ transitions to the low level from the high level. When both the data lines D+ and D− have low levels for the predetermined time T1, the USB host 110 detects a state of disconnection with the bus-powered high-speed USB client 220. The USB host 110 turns the switch SW1 off and initializes its internal condition for the predetermined time T2. The USB host 110 turns the switch SW1 on to supply the power voltage to the bus-powered high-speed USB client 220; the switch SW1 being connected to the power line Vbus. The bus-powered high-speed USB client 220 turns the switch SW2 on if the power voltage is supplied through the power line Vbus. Responding to the conduction of the switch SW2, the positive data line D+ transitions to the high level from the low level. When one of the data lines D+ and D− has the high level for the predetermined time T3, the USB host 110 detects a state of connection with the bus-powered high-speed USB client 220 and resumes data communication with the bus-powered high-speed USB client 220.

In FIG. 10, there is shown a voltage variation on the power line Vbus, which is connected to the bus-powered high-speed USB client 220 from the USB host 110, by an operation of the switch SW1. If the USB host 110 detects disconnection with the bus-powered high-speed USB client 220, the switch SW1 is turned off to interrupt the power voltage supply for the bus-powered high-speed USB client 220.

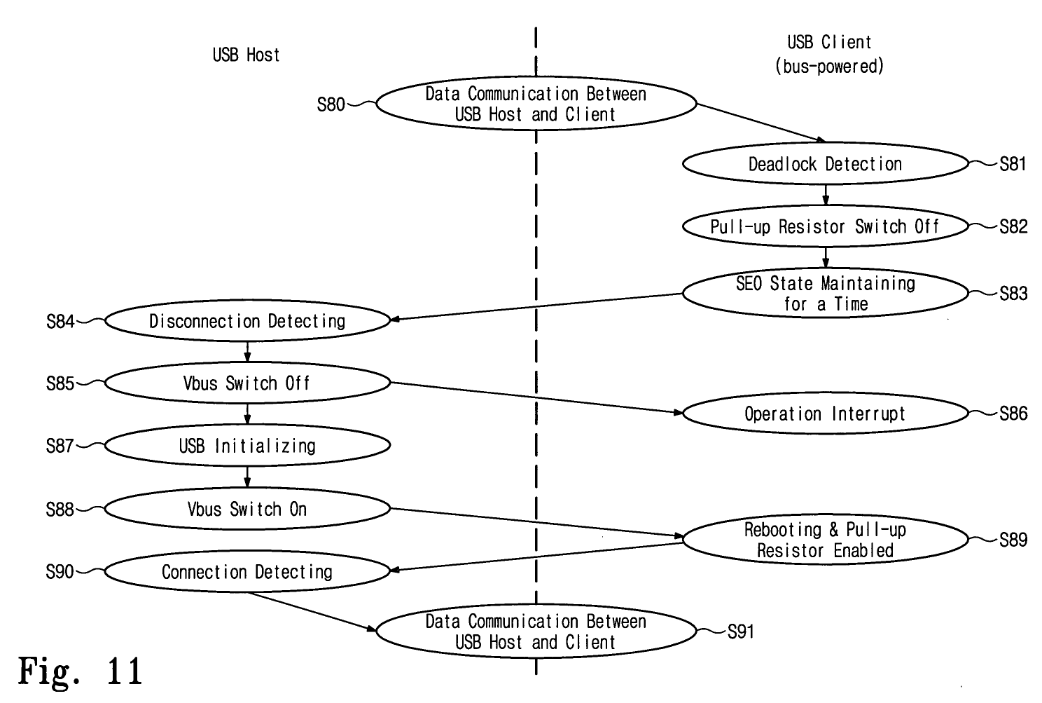

FIG. 11 is a transition diagram illustrating an operation of the USB system 30 shown in FIG. 9. During data communication between the USB host 110 and the bus-powered high-speed USB client 220 (S80), if a deadlock is detected by the bus-powered high-speed USB client 220 (S81), the bus-powered high-speed USB client 220 disables the switch SW2 that is connected to the pull-up resistor R3 (S82). If the switch SW2 is turned off, the data lines D+ and D− are all put into the SE0 state where they are maintained at low levels (S83). In the SE0 state, the USB host 110 detects a state of disconnection with the bus-powered high-speed USB client 220 (S84). Then, the USB host 110 turns the switch SW1 off (S85), the switch SW1 being connected with the power line Vbus. Thereafter, an internal state of the USB host 110 is initialized (S87). The USB host 110 turns the switch SW1 on (S88) to supply the power voltage to the bus-powered high-speed USB device 220, the switch SW1 being connected with the power line Vbus. Thereby, the bus-powered high-speed USB client 220 is rebooted by the power supply and the positive data line D+ is transitioned to the high level (S89). When one of the data lines D+ and D− has the high level for the predetermined time T3, the USB host 110 detects a state of connection with the bus-powered high-speed USB client 220 (S90) and resumes data communication with the bus-powered high-speed USB client 220 (S91).

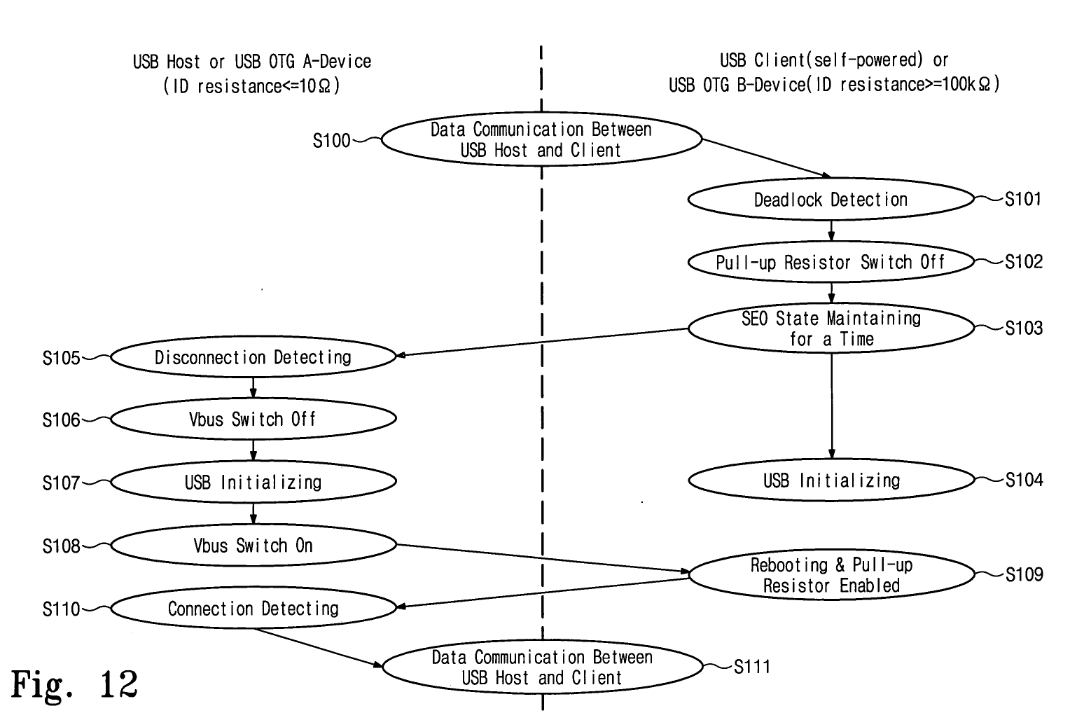

FIG. 12 is a transition diagram illustrating another operation of the USB system 30 shown in FIG. 9. In the USB system 30 of FIG. 12, the host is a general USB host or the USB OTG A-device while the client is the self-powered high-speed USB client or the USB OTG B-device. The configuration of the state transitions shown in FIG. 12 is as same with that of FIG. 11, and further includes initializing an internal condition of the USB client by itself (S104) in the SE0 state (S103).

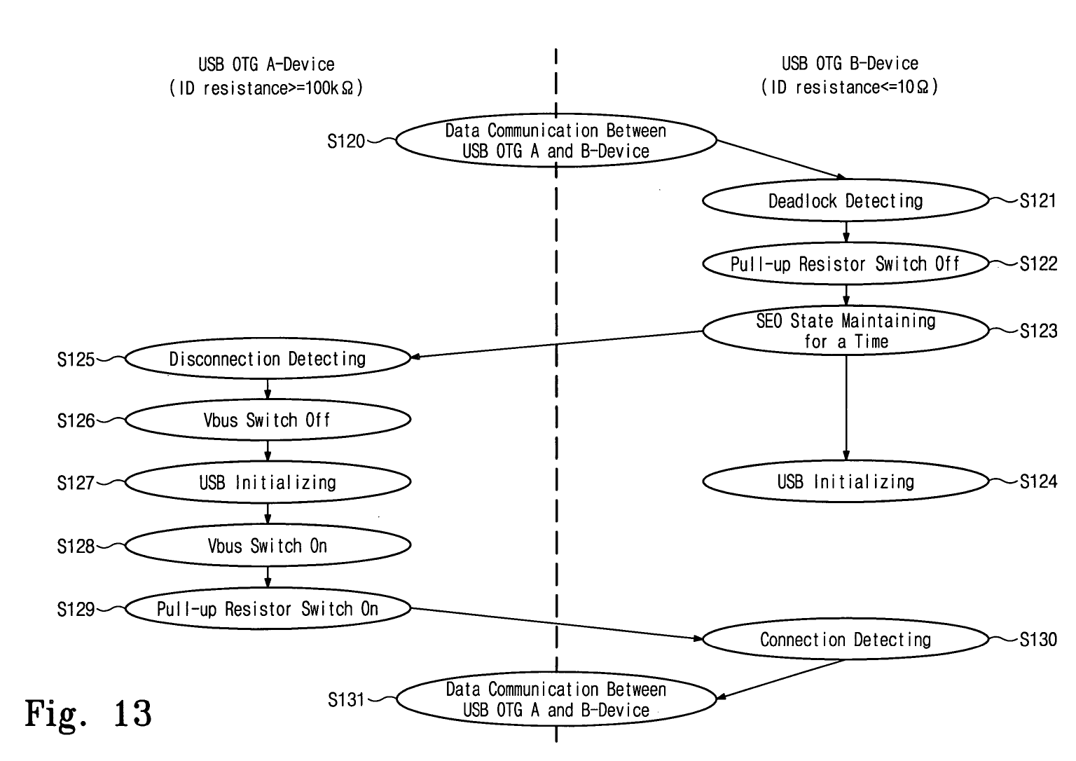

FIG. 13 is a transition diagram illustrating still another operation of the USB system 30 shown in FIG. 9. The USB OTG system shown in FIG. 13 is set by altering the functions of the host and device from the USB OTG system of FIG. 12 by means of HNP. When the functions of the USB host and client are changed by HNP while the USB OTG system is operating, a deadlock condition occurs to cut off connection between the two USB devices and the allocation of functions is re-established as the initial configuration when the systems are reconnected. Thereafter, if the functions are to be changed, they are changed to each other by means of HNP.

In addition to the aforementioned schemes, a configuration may include a button to reconnect the USB system to the USB host or device. When a USB user identifies a deadlock, the button is used to control the switches SW1 and SW2 to force the reconnection for the USB system.

As such, it is possible to reconnect the USB system by means of the switches, without physically removing and reconnecting the USB cable, when a deadlock condition occurs in the USB system.

The USB systems according to embodiments of the present invention are applicable to various electronic apparatuses employing them, such as personal computers, MP3 players, mobile phones, PDAs, digital cameras, photo-printers, and so forth.

The above-disclosed subject matter is to be considered illustrative, not restrictive, and the appended claims are intended to cover all such modifications, enhancements, and embodiments, which fall within the spirit and scope of the disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A Universal Serial Bus (USB) system comprising:
a host device; and
at least one client device connected to the host device through a USB connection, wherein the host device interrupts a power supply to the client device through a power line when there is a deadlock condition and resumes the power supply to the client device after an initialization.

2. The USB system as set forth in claim 1, wherein the host device comprises a first switch connected to the power line for regulating the power supply to the client device.

3. The USB system as set forth in claim 2, wherein the client device comprises a pull-up resistor connected to a data line of the USB connection, the pull-up resistor being connected to a second switch.

4. The USB system as set forth in claim 3, wherein the second switch disconnects the data line from the pull-up resistor when the power supply through the power line is interrupted, and connects the data line with the pull-up resistor when the power supply resumes.

5. The USB system as set forth in claim 4, wherein the host device detects connection between the host device and the client device in response to a condition of the data line.

6. The USB system as set forth in claim 2, wherein the host device comprises a deadlock detector to detect the deadlock condition.

7. The USB system as set forth in claim 6, wherein the first switch is controlled in response to a detection result of the deadlock detector.

8. A Universal Serial Bus (USB) system comprising:
a downstream port transceiver connected to a USB connection;
a deadlock detector detecting a deadlock condition in response to a signal input to the downstream port transceiver; and
a switch connected between the downstream port transceiver and a power line of the USB connection, controlling a power supply through the power line in accordance with a detection result of the deadlock detector.

9. The USB system as set forth in claim 8, wherein the switch interrupts the power supply when there is the deadlock condition.

10. A Universal Serial Bus (USB) system comprising:
a host device; and
a client device connected to the host device through a USB connection,
wherein the client device disconnects a pull-up resistor from a data line of the USB connection is response to a deadlock condition, while the host device interrupts a power supply to the client device through a power line of the USB connection in response to a signal of the data line and resumes the power supply to the client device after an initialization.

11. The USB system as set forth in claim 10, wherein the host device comprises a first switch to regulate the power supply.

12. The USB system as set forth in claim 11, wherein the client device comprises a second switch to regulate connection between the data line and the pull-up resistor.

13. The USB system as set forth in claim 12, wherein the client device comprises a deadlock detector to detect the deadlock condition.

14. The USB system as set forth in claim 13, wherein the second switch is controlled in response to a detection result of the deadlock detector.

15. A method of driving a Universal Serial Bus (USB) system including a host device and a client device connected to the host through a USB connection, the method comprising:
detecting a deadlock condition;
interrupting a power supply through a power line in response to the deadlock condition;
detecting a disconnection between the host device and the client device and conducting an initialization; and
resuming the power supply through the power line after the initialization.

16. The method as set forth in claim 15, wherein the host device comprises a first switch connected with the power line for regulating the power supply to the client device.

17. The method as set forth in claim 16, wherein the client device comprises a pull-up resistor connected to a data line of the USB connection, the pull-up resistor being connected with a second switch.

18. The method as set forth in claim 17, wherein the second switch disconnects the data line from the pull-up resistor when the power supply through the power line is interrupted, and connects the data line with the pull-up resistor when the power supply resumes.

19. The method as set forth in claim 18, wherein the host device detects connection between the host device and the client device in response to a condition of the data line.
